(19) United States
(12) Patent Application Publication
(10) Pub. No.: US 2006/0099021 A1
(43) Pub. Date: May 11, 2006

(54) Original position setting apparatus, recording apparatus and control method for the same

(75) Inventor: Nobuhiro Inoue, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/217,160

(22) Filed: Aug. 31, 2005

(30) Foreign Application Priority Data
Nov. 10, 2004 (JP) 2004-326062

(51) Int. Cl. B41J 29/38

(52) U.S. Cl. 400/76

(57) ABSTRACT

An original position setting apparatus for driving a driven member by a stepping motor and abutting the driven member against an original position setting member to set an original position of the driven member, wherein the original position apparatus includes a drive control section that periodically drives the stepping motor until the driven member abuts the original setting member, when the driven member is returned to the original position.

This application is based on Japanese Patent application JP 2004-326062, filed Nov. 10, 2004, the entire content of which is hereby incorporated by reference. This claim for priority benefit is being filed concurrently with the filing of this application.

### BACKGROUND OF THE INVENTION

1. Technical Field of the Invention

The present invention relates to an original position setting apparatus, recording apparatus and control method for the same, and more particularly to an apparatus for setting an original position of a driven member to be driven by a stepping motor without using a position detector.

2. Description of the Related Art

In the related art, there is known a mechanism for driving a driven member by use of a stepping motor.

In such a mechanism, in order to set the position of the driven member without using a position detector, the driven member or a member to be driven in unison with the driven member is abutted against an abutting member having an original position as a reference, thereby stepping out the stepping motor. This makes it possible to deduce an abutment of the driven member or the member to be driven in unison with the driven member against the abutting member. By defining this state as positioned at the original position reference point, control operation is to be done for transition (see JP-A-5-236800).

As shown in FIG. 25, even where the stepping motor is made a slow-up control to drive the driven member toward the abutting member wherein driving is from a position the driven member is presumed the most distant from the abutting member, it is a practice to take a structure that supplies the stepping motor with drive pulses in the number the driven member or the member to be driven in unison with the driven member is positively caused to hit against the abutting member.

Specifically, provided that 850 drive pulses are required to abut the driven member against the abutting member from a position presumed to be the most distant from the abutting member, nearly 900 drive pulses are outputted to the stepping motor with a margin.

Namely, as shown in FIG. 25, the drive frequency to the stepping motor is raised up to 1200 Hz during slow-up control of approximately 30 output drive pulses. Then, the motor drive frequency is held at 1200 Hz, to make a constant driving. Furthermore, at a time that output drive pulses become nearly 870 in number, slow-down control is effected. When output drive pulses become 900 in number, the stepping motor is stopped.

Meanwhile, in the case of selecting a stepping motor, stepping motor having a drive force capable of driving even in the maximum load state presumed in the use environment of the relevant stepping motor is selected.

In an apparatus having a large load fluctuation, a stepping motor that has a large drive force and has the related art structure is used. However, in a state where the load applied in a vicinity of the original position is small, when setting the driven member to the original position, there is an increased amount of impact when the driven member abuts the abutting member. As a result, an increased amount of bounce occurs in the state the abutting member is abutted against the driven member or the member to be driven in unison with the driven member. This possibly causes a case in which the driven member or the member to be driven in unison with the driven member is not necessarily presumed existent at the original position. Furthermore, by the bounce due to the impact, phase shifting possibly arises in the stepping motor. Therefore, the stepping motor is placed in synchronism and rotate-drives into a reverse direction.

### SUMMARY OF THE INVENTION

It is an object of at least one embodiment of the present invention to provide an original position setting apparatus, recording apparatus and control method for the same capable of positively setting an original position of a driven member to be driven by a stepping motor even when used in an apparatus great in load fluctuation. The object of the invention can be achieved by at least the following embodiment of the invention.

An original position setting apparatus for driving a driven member by a stepping motor and abutting the driven member against an original position setting member to set an original position of the driven member, wherein the original position apparatus comprises a drive control section that periodically drives the stepping motor until the driven member abuts the original position setting member, when the driven member is returned to the original position.

### BRIEF DESCRIPTION OF THE DRAWINGS

FIG. 1 is a front perspective view showing an exterior view of a recording apparatus 10.

FIG. 2 is a perspective view showing a state in which an upper cover 12, an upper housing 13 and a lower housing 14 are removed from the recording apparatus 10.

FIG. 3 is a perspective view showing a state in which a clamper 32 and a ribbon cassette 60 are further removed from FIG. 2 wherein a main body upper part 16 is opened.

FIG. 4 is a sectional view of the recording apparatus of FIG. 1 taken vertically along a transport direction of recording paper 100.

FIG. 5 is a side view on a side provided with a stepping motor in a state in which the upper cover 12, the upper housing 13, the lower housing 14 and the main body upper part 16 are removed from the recording apparatus 10.

FIG. 6 is a sectional view taken in a motor pinion position provided on a drive shaft of the stepping motor in FIG. 5.

FIG. 7 is a side view showing an example of a cam-link mechanism in a first status of the invention.

FIG. 8 is a perspective view of FIG. 7.

FIG. 9 is an explanatory view of relationship between a first cam 390 and cam follower pin 819, in the first status.

FIG. 10 is an explanatory view of relationship between a first cam 390 and cam follower pin 398, in the first status.

FIG. 11 is an explanatory view of relationship between a first cam 390 and cam follower pin 819, in the second status.

FIG. 12 is an explanatory view of relationship between a first cam 390 and cam follower pin 398, in the second status.

FIG. 13 is a side view showing an example of a cam-link mechanism in the second status.

FIG. 14 is an explanatory view of relationship between a first cam 390 and cam follower pin 819, in the third status.

FIG. 15 is an explanatory view of relationship between a first cam 390 and cam follower pin 398, in the third status.

FIG. 16 is a side view showing an example of a cam-link mechanism in the third status.

FIG. 17 is a timing chart showing the operation of an arrangement plate 360, clamper 32 and movable paper guide 851.

FIG. 18 is an explanatory view of load variation.

FIG. 19 is a process flowchart at initialization in this embodiment.

FIG. 20 is an explanatory view of a motor drive waveform in the embodiment based on the FIG. 19 flowchart.

FIG. 21 is a magnified waveform diagram in rough feed.

FIG. 22 is a magnified waveform diagram in fine feed.

FIG. 23 is an explanatory view of a motor drive waveform in a first modification.

FIG. 24 is an explanatory view of a motor drive waveform in a second modification.

FIG. 25 is an explanatory view of a motor drive waveform in the prior art.

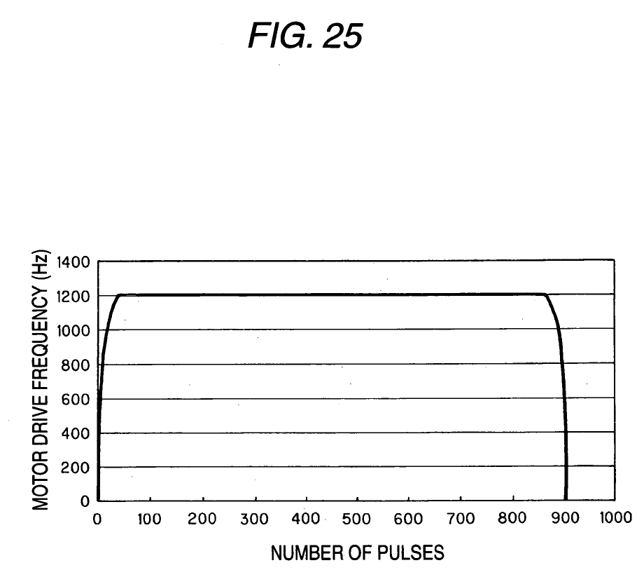

### DETAILED DESCRIPTION OF THE INVENTION

With reference to the drawings, explanations will now made on the preferred embodiment of the present invention.

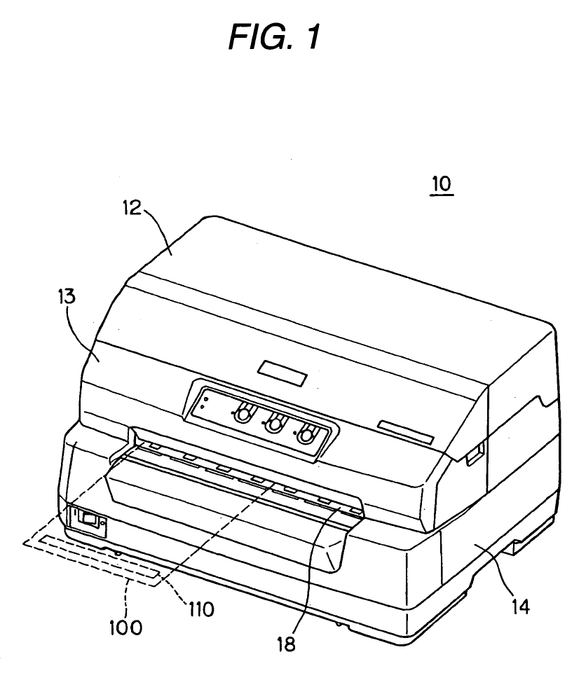

FIG. 1 is a front perspective view showing an exterior view of a recording apparatus constructed as a dot-impact printer.

The recording apparatus 10 has an upper cover 12, an upper housing 13 and a lower housing 14. In a front surface of the recording apparatus 10, there is provided an insertion aperture 18 through which is to be inserted a recording paper (recording medium) 100 including a book-type recording medium such as a bankbook, cut-sheet recording medium such as a cut sheet, and a copying recording medium such as a copying paper. When a recording paper 100 is inserted in the insertion aperture 18, recording is done to the recording paper 100 and then the recording paper 100 is discharged through the insertion aperture 18.

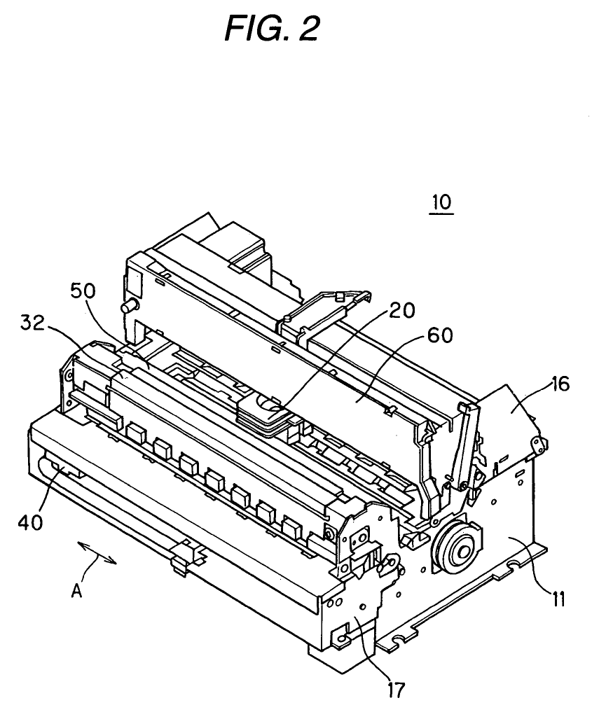

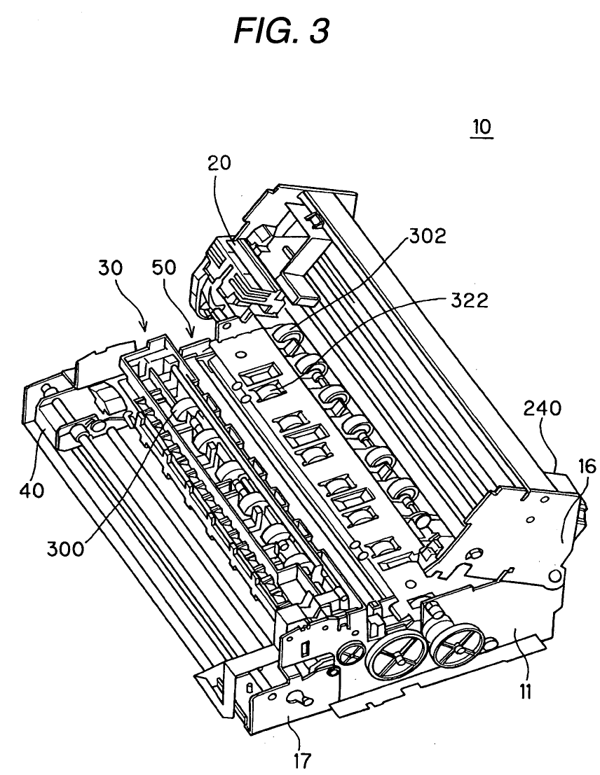

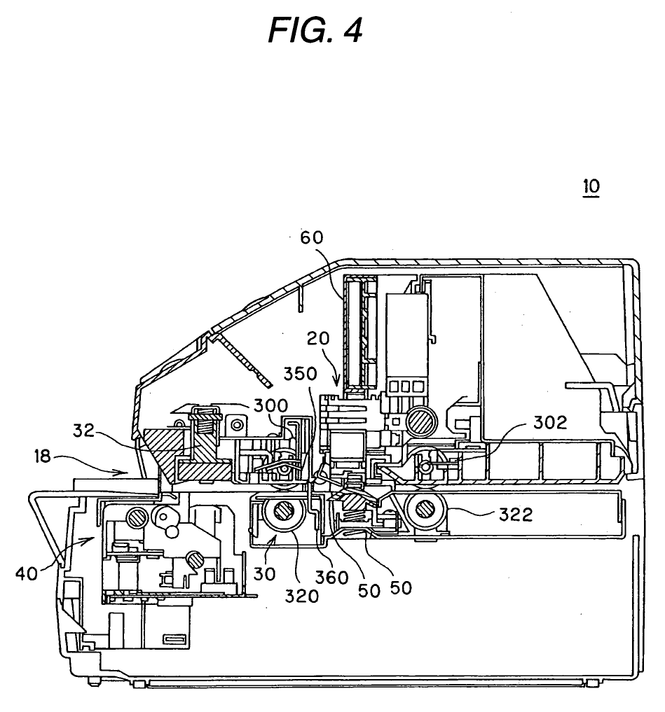

Meanwhile, in the recording apparatus 10, the upper cover 12 is arranged removable in the event of jamming or the like of a recording paper 100. From now on, explanation is made by way of recording paper 100 which is a bankbook bound with a plurality of recording sheets and provided with a magnetic stripe 110 on a cover (back cover) on the back as the recording page is opened. FIG. 2 is a perspective view showing the recording apparatus in a state in which the upper cover, the upper housing and the lower housing are removed. FIG. 3 is a perspective view showing the state of FIG. 2 in which a clamper for holding a recording paper and a ribbon cassette are removed, and whose main body upper part is opened. FIG. 4 is a side sectional view of the recording apparatus.

As shown in FIGS. 2 to 4, the recording apparatus 10 has a transporter 30 for transporting a recording paper 100 inserted through the insertion aperture 18, a clamper 32 for holding the recording paper 100 so that it does not float up during reading/writing of magnetic information, a magnetic data reader/writer 40 for reading or writing magnetic information from or to the magnetic stripe 110 provided on the recording paper 100, a platen 50 for supporting the recording paper from below, and a recording apparatus 20 arranged opposed to the platen 50 and for making a recording to the recording paper 100 by a recording head 200 with use of a ribbon cassette 60.

As shown in FIG. 3, the main body upper part 16 having the recording apparatus 20 can be opened and closed relative to the main body 11 having the platen 50. In the event of jamming of a recording paper 100 between the main body 11 and the main body upper part 16, the recording paper 100 can be easily removed away.

As shown in FIG. 4, the transporter 30 has a front pressure applier 300 supported on the main body 11 frontward rather than the recording apparatus 20 (leftward in FIG. 4), a front transporter 320 arranged in the main body 11 oppositely to the below of the front pressure applier 300, an alignment plate 360 arranged deeper than the front pressure applier 300 and front transporter 320 (rightward in FIG. 4) but frontward of the platen 50 thus enabled to advance/retract into/from a transport path of recording paper 100, a rear pressure applier 302 supported on the main body upper part 16 in a position deeper than the recording apparatus 20, and a rear transporter 322 arranged in the main body 11 oppositely to the lower part of the rear pressure applier 302.

Here, the operation outline of the recording apparatus 10 is explained. At first, in case a recording paper 100 is inserted through the insertion aperture 18, the front pressure applier 300 and front transporter 320 clamps the recording paper 100 and transports it to a front of the platen 50.

At this time, the alignment plate 360 is advanced in the transport path of the recording paper in order to correct for the inclination (skew) of the recording paper 100 with respect to transportation thereof. The recording paper 100 is to be aligned by being transported furthermore while being abutted against the alignment plate 360.

After aligning the recording paper 100, the transporter 30 transports the recording paper 100 until the magnetic stripe 110 provided in the bottom of the recording paper 100 comes to a read/write point of the magnetic data reader/writer 40. Thereafter, the magnetic data reader/writer 40 moves lengthwise of the main body front part 17 (in a direction of arrow A in FIG. 2), to read magnetic information out of the magnetic stripe 110 provided on the back of the recording paper 100 (front cover or back cover).

Furthermore, when the transporter 30 transports the recording paper 100 to a recording position over the platen 50, the recording apparatus 20 hits a recording apparatus 20 wire to the recording paper 100 transported to the platen 50 through an ink ribbon of a ribbon cassette 60 while moving lengthwise of the main body 11 (in a direction of arrow A in FIG. 2) over the recording paper 100, depending upon the magnetic information read out by the magnetic data reader/writer 40, thereby making a recording of a character, etc. onto the recording paper 100.

Then, the transporter 30 transports the recording paper 100 up to the read/write position.

At this time, the magnetic data reader/writer 40 again moves lengthwise of the main body front part 17 and writes magnetic information to the magnetic stripe 110 depending upon the information recorded on the recording paper 100.

The transporter 30 transports the recording paper 100 forward and discharges the recording paper 100 recording has been completed through the insertion aperture 18.

Now explanation is made on the original position setting function of a cam functioning as an original position setting apparatus according to the invention.

First, a cam-link mechanism concerned is explained in advance of explaining the original position setting function.

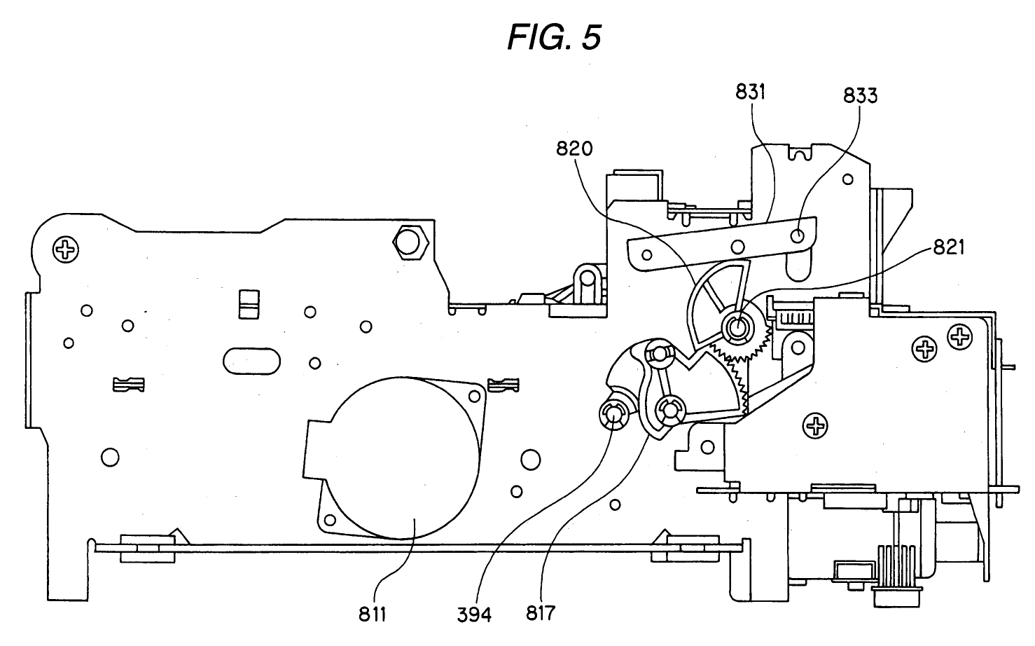

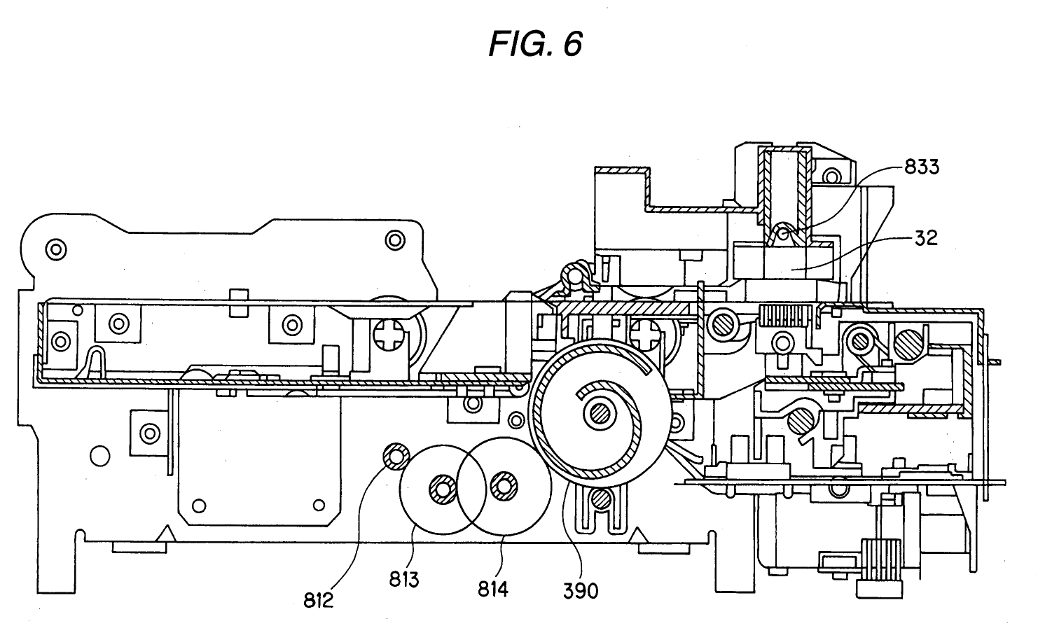

FIG. 5 is a side view on a side provided with a stepping motor according to the invention, in a state the upper cover 12, the upper housing 13, the lower housing 14 and the main body upper part 16 are removed from the recording apparatus 10. Meanwhile, FIG. 6 is a sectional view taken in a position of a motor pinion provided on a drive shaft of the FIG. 5 stepping motor.

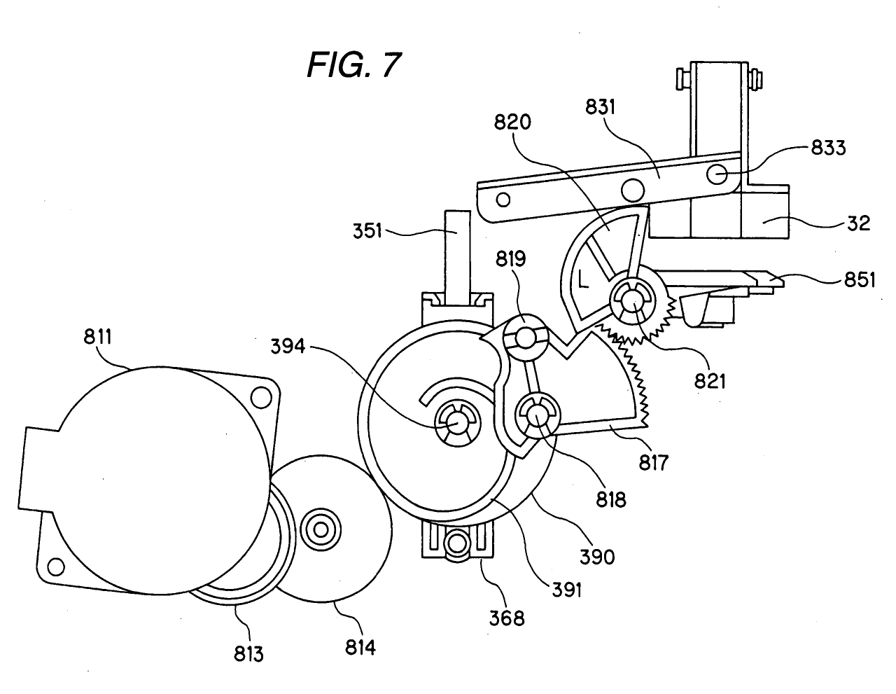

The stepping motor 811 rotates a first cam 390 through a motor pinion 812 and gears 813, 814, as shown in FIGS. 5 and 6. The first cam 390 drives a follower member 368 (see FIG. 7), referred later, based on the rotation thereof and moves the alignment plate 360 vertically (see FIG. 4). Simultaneously, the first cam 390 operates a first cam follower 817, second cam 820 and second cam follower 831 based on the rotation thereof, to move the clamper 32 vertically through a pushup pin fixed at an end of the second cam follower 831. At this time, the second cam 820 opens and closes a movable paper guide 851 (see FIG. 7), referred later, through a camshaft 821.

The recording apparatus 10 changes the position of the alignment plate 360, movable paper guide 851 and clamper 32, in accordance with operation status.

The alignment plate 360, movable paper guide 851 and clamper 32, to be driven by the first cam 390, is hereinafter referred to as a cam-link mechanism.

The cam-link mechanism is to take the following operation statuses.

First status: operation status from insertion of a recording paper 100 up to skew correction.

Second status: operation status during transporting of the recording paper 100 after skew correction.

Third status: operation status in which a magnetic head 410 makes a scanning of the magnetic stripe 110.

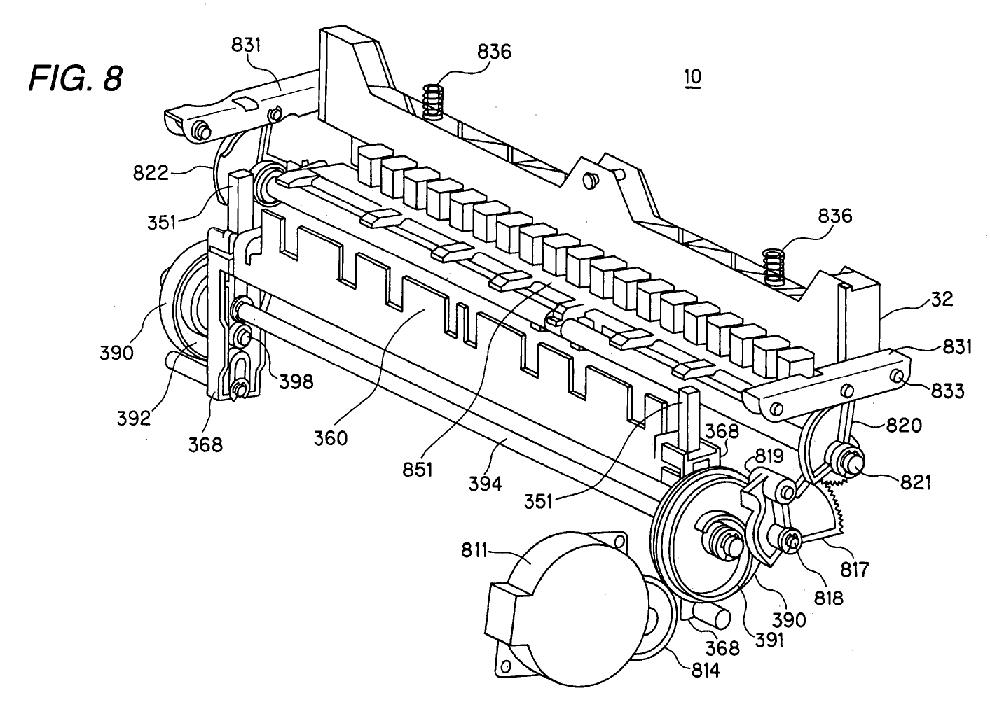

FIG. 7 is a side view showing a status of the cam-link mechanism in the first status. FIG. 8 is a perspective view showing a status of the cam-link mechanism in the first status.

In FIGS. 7 and 8, omitted are the other members than the mechanism elements to be driven by the motor 811 in order to facilitate explanation.

In the first status, the movable paper guide 851 advances in the transport path of recording paper 100 and supports the recording paper 100. The clamper 32 is retracted up in order not to obstruct the recording-subject 100. Meanwhile, the alignment plate 360 is in an advanced position where to obstruct the transport path of recording paper 100.

The first cam 390 is a disk cam member rotating about a camshaft 394. This has a cam groove in one surface with respect to the axis of the camshaft 394, and a cam rib in the other surface. In this embodiment, the first cam 390 is provided in a pair at both ends of the camshaft 394. In FIG. 8, assuming that the center of the recording apparatus 10 is taken inward, the first cam 390 is arranged such that its cam groove 392 is positioned inward while the cam rib 391 is outward.

The first cam 390 moves the alignment plate 360 vertically by means of the cam groove 392 provided oppositely inward and operates the clamper 32 and movable paper guide 851 by means of the cam rib 391 provided outward (however, only the first cam 390 provided toward this, in the embodiment). By thus operating the alignment plate 360, the clamper 32 and the movable paper guide 851 by the same first cam 390, space saving and component cost reduction are realized. Meanwhile, the cam-link mechanism in this embodiment has a high layout efficiency in terms of the structure of recording apparatus 10 to be arranged in the region along the left and right frames.

Now explained is the contrivance that the first cam 390 operates the clamper 32 and the movable paper guide 851.

The first cam follower 817 has a cam follower pin 819 acting along the profile of the cam rob 391. Due to this, the first cam follower 817 is allowed to swing about a cam follower shaft 818 as the first cam 390 rotates forward and reverse. The first cam follower 817 has a gear, provided in a part of the outer periphery thereof, in mesh with the gear provided in a part of the second cam 820. Accordingly, swinging the first cam follower 817 causes the second cam 820 to swing about the camshaft 821. The camshaft 821 is fixed to the second cam 820, to deliver the swing of second cam 820 to the second cam 822 fixed at the other end. The second cam 822 has its one end engaged with the movable paper guide 851 through a coil spring, to vertically move the movable paper guide 851 due to the rotation force delivered from the camshaft 821.

Furthermore, the second cam 820 and the second cam 822 has the same cam profile, whose swing causes the second cam followers 831 in the left and right to vertically move at the same time. Above the clamper 32, a compression coiled spring 836, having an upper end fixed to the frame of the front pressure applier 300, urges the clamper 32 down. The second cam followers 831 in the left and right have ends fixed with pushup pins 833 to push up the both ends of a recording-subject clamper 32. As the second cam follower 831 ascends, the clamper 32 is moved up against the urge force of the compression coiled spring 836. This releases the clamper 32 from holding down the recording paper 100.

Here, concerning the cam-link mechanism including the cam rib 391, the first cam follower 817, the second cam 820, the second cam follower 831 and the pushup pin 833, when the cam follower pin 819 is most distant in position of the cam profile of cam rib 391 from the camshaft 394, the clamper 32 is in retraction above the transport path of recording paper 100 wherein the movable paper guide 851, in combination, is to advance toward the transport path of recording paper 100, i.e. toward the above.

When the cam follower pin 819 comes near the camshaft 394 along the cam rib from the above state, the cam-link mechanism moves associatively to descend the clamper 32 toward the transport path of recording paper 100. At this time, the second cam 822 moves associatively in a manner to retract the movable paper guide 851 from the transport path of recording subject 100.

Meanwhile, when the follower member ascends due to rotation of the first cam 390, the alignment plate 360 at its upper end ultimately goes into abutment against a bottom 384 of the pressurizing-roller-side frame 380. Due to this, the alignment plate 360 advances in the transport path of recording paper 100. Meanwhile, when the follower member 368 descends due to reverse rotation of the first cam 390, the alignment plate 360 descends correspondingly to retract from the transport path of recording paper 100.

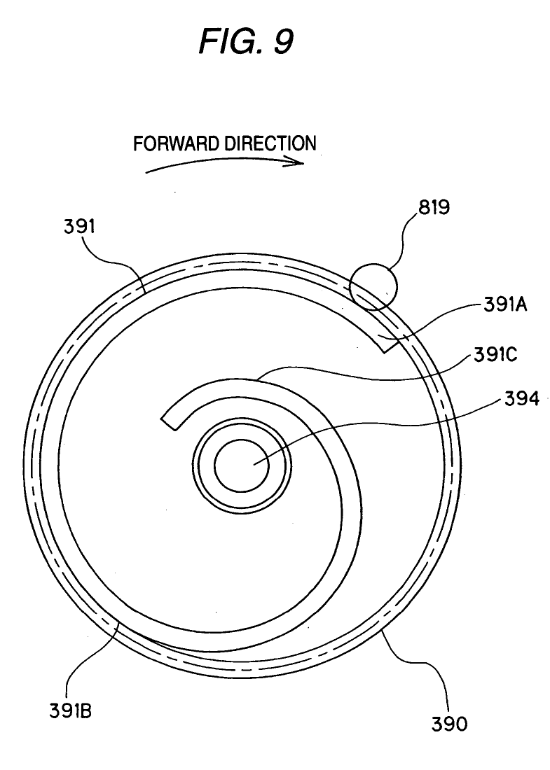

FIG. 9 is an explanatory view of relationship between the left, first cam 390 and the cam follower pin 819, in the first status.

The cam rib 391 has a spiral cam profile having nearly a half turn portion of from the outermost peripheral end 391 (up to a vicinity of position 391B) positioned in the outermost periphery of the first cam 390 and its tip portion extending gradually nearing the camshaft 394. At or around a point 391C made one round from the outermost peripheral end 391A, it becomes nearest in forming to the camshaft 394.

The cam follower pin 819 swings depicting an arcuate path obliquely above the cam shaft 394. In the first status, the cam follower pin 819 positions close to the outermost peripheral end 391A of the cam rob 391, as shown in FIG. 9. Incidentally, rotation of the first cam 390 is taken forward in the arrow direction in FIG. 9.

During a half rotation of the first cam 390 forward from the first status, the cam follower pin 819 positions the most distant obliquely above the camshaft 394. Thereafter, as the first cam 390 further rotates forward, the cam follower pin 819 gradually moves toward the camshaft 394, i.e. descends, and nears the closest to the camshaft 394 at nearly one round (at or around position 391C) from the first status.

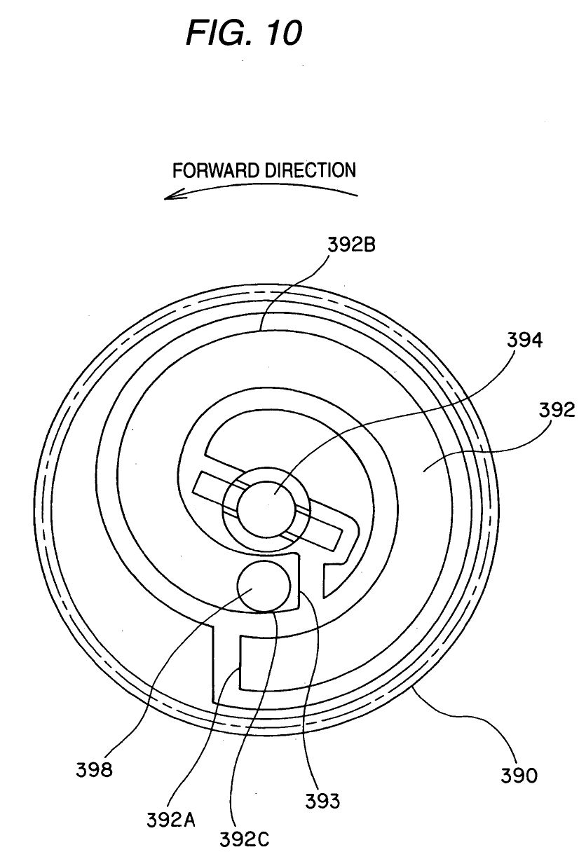

FIG. 10 is an explanatory view of relationship between the first cam 390 and the cam follower pin 398, in the first status.

FIG. 10 corresponds to the opposite surface of the first cam 390 in the same position shown in FIG. 9.

The cam groove 392 has a spiral cam profile having nearly a half turn portion of from the outermost peripheral end (position 392A) (up to a vicinity of position 392B) positioned in the outermost periphery of the first cam 390 and its tip portion extending gradually nearing the camshaft 394. At one round from the outermost peripheral end (at or around the position 392C), it becomes nearest in forming to the camshaft 394. A wall-like stroke end 393 is formed in the cam profile end closer to the camshaft 394, to abut against the cam follower pin 398.

The cam follower pin 819 vertically moves below the camshaft 394. In the first status, the cam follower pin 398 lies nearby the stroke end 393, i.e. the upper limit position nearest to the camshaft 394. As the first cam 390 rotates forward, the cam follower pin 398 moves in a direction away from the camshaft 394, i.e. descends, and reaches the lower limit most distant from the camshaft 394 nearly at a half turn. Thereafter, during a further half forward turn, the cam follower pin 398 is in a lower limit position most distant from the camshaft 394.

In the first status, the cam follower pins 819, 398 are both in the upper limit in a range of movement. When the first cam 390 rotates a half turn from this status, the cam-link mechanism in this embodiment changes into a second status.

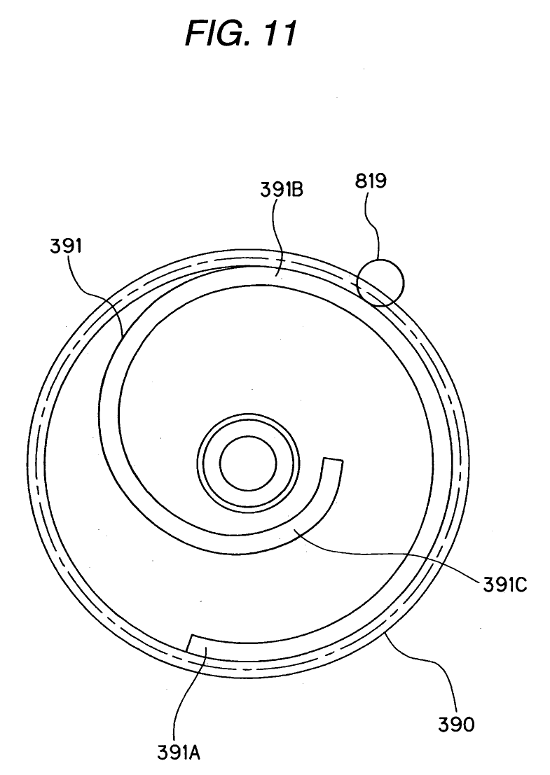

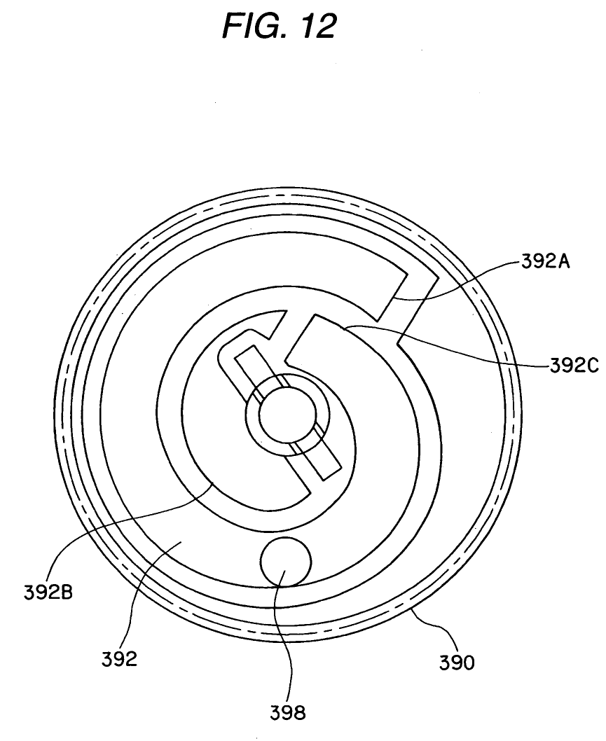

FIGS. 11 and 12 are explanatory views of a relationship between the first cam 390, the cam follower pin 819 and the cam follower pin 398, in the second status.

FIG. 12 corresponds to the opposite surface of the first cam 390 in the same position shown in FIG. 11. In the change process from the first to second status, the cam follower pin 819 remains in the upper limit position in the movement range without making a movement. Meanwhile, the cam follower pin 398 gradually descends with rotation of the first cam 390, to reach the lower limit in the moving range nearly at a half-turn from the first status.

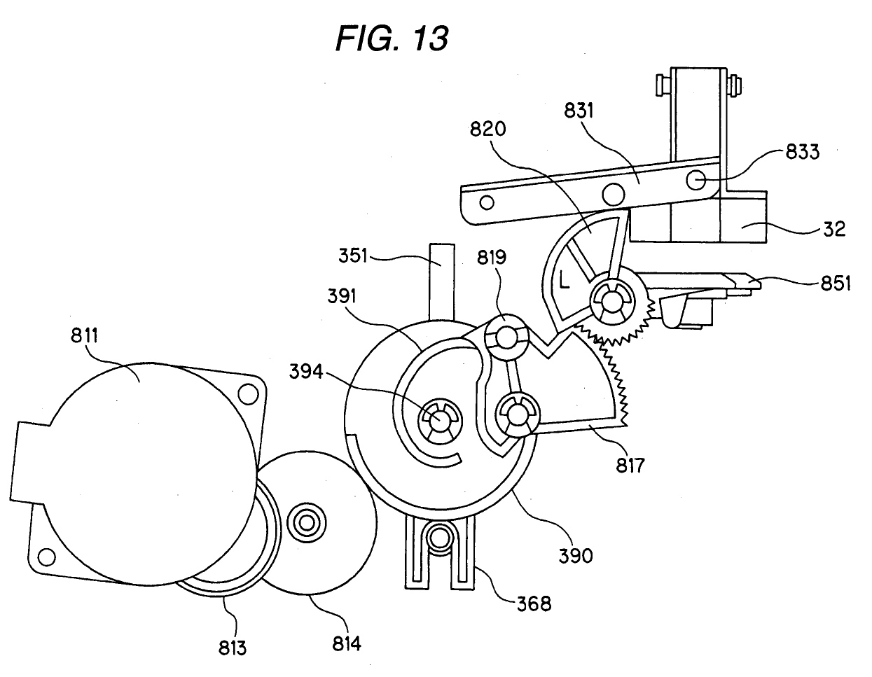

FIG. 13 is a side view showing an example of a cam-link mechanism in the second status.

The cam follower pin 819 is unchanged in position from the first status, thus being in the most distant position from the camshaft 394. Accordingly, the clamper 32 is in retraction above from the transport path of recording paper 100 while the movable paper guide 851 is in advancement in the transport path of recording paper 100.

Meanwhile, the cam follower pin 398 is in the lower limit position the most distant from the camshaft as shown in FIG. 12, thus pushing up the follower member 368 and the pushup member 351. Accordingly, the alignment plate 360 is in retraction below the transport path of recording paper 100. When the first cam 390 further forward rotates a half turn from this status, the cam-link mechanism of this embodiment changes into a third status.

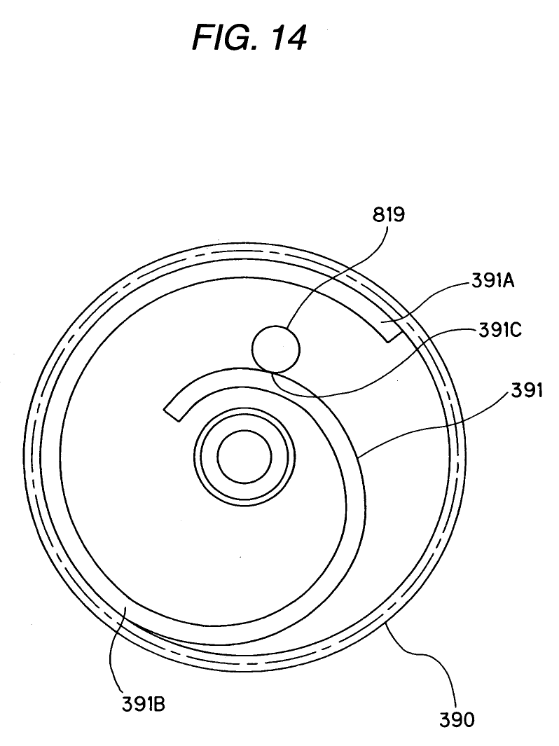

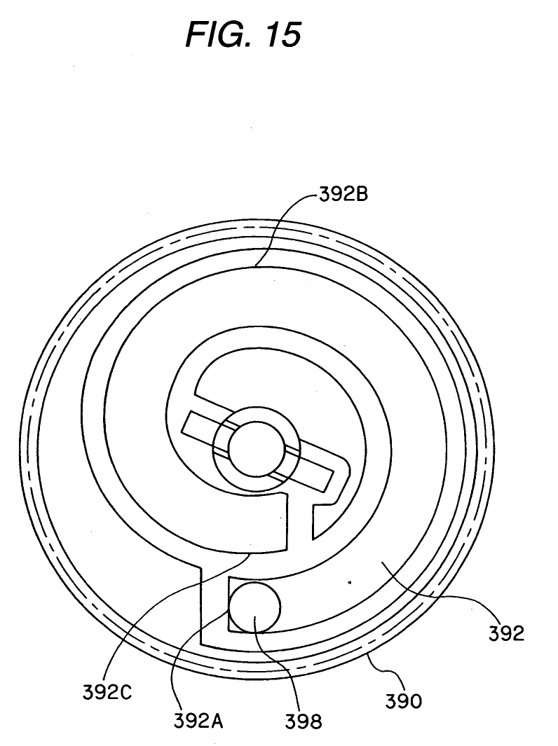

FIGS. 14 and 15 are explanatory views of relationship between the first cam 390, the cam follower pin 819 and the cam follower pin 398, in the third status.

FIG. 15 corresponds to the opposite surface of the first cam 390 in the same position shown in FIG. 14. In the change process of from the second to third status, the cam follower pin 398 gradually descends, to reach the lower limit in the moving range, i.e. the nearest position to the camshaft 394, nearly at a half turn from the second status. In this duration, the cam follower pin 398 remains in the lower limit of the movement range without making a movement.

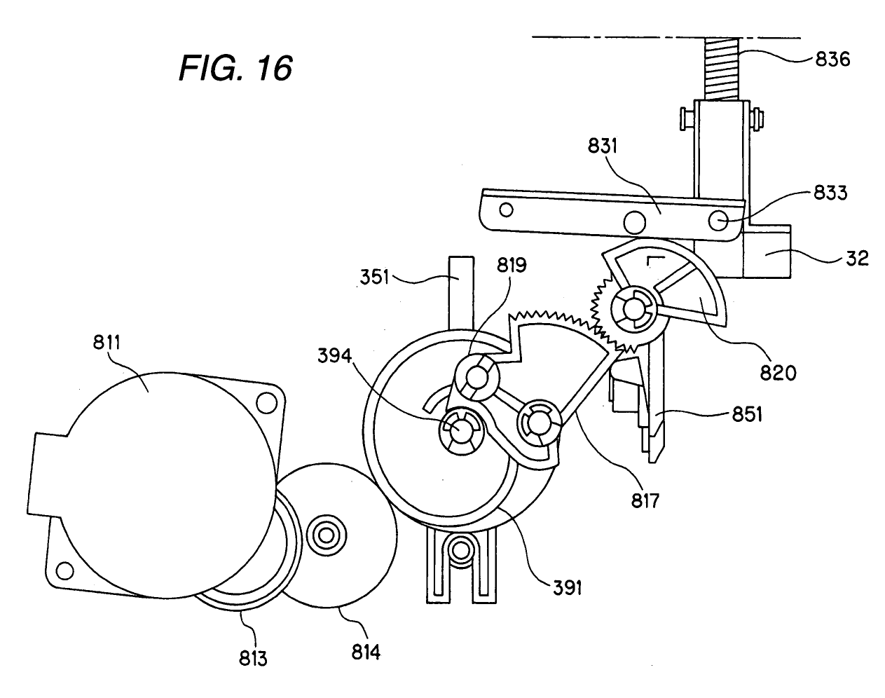

FIG. 16 is a side view showing an example of a cam-link mechanism in the third status. The cam follower pin 819 is in the nearest position to the camshaft 394. Accordingly, the clamper 32 is descended down to a position where to urge the recording paper 100 to the magnetic head 410 while the movable paper guide 851 is in retraction below from the transport path of recording paper 100, thus releasing the scanning path of magnetic head 410.

Meanwhile, the cam follower pin 398 is in the lower limit position the most distant from the camshaft 394 as shown in FIG. 15, thus pushing down the follower member 368 and the pushup member 351. Accordingly, the alignment plate 360 is in retraction below from the transport path of recording paper 100.

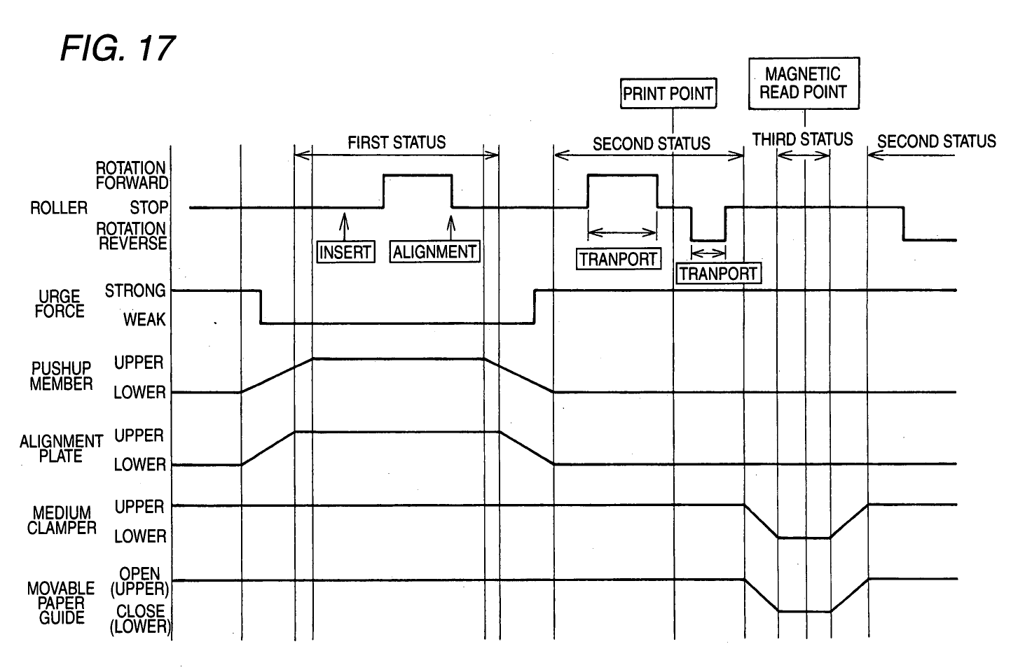

FIG. 17 is a timing chart showing the operation of the alignment plate 360, clamper 32 and movable paper guide 851. Due to a series of operations of the timing chart, the recording apparatus 10 performs alignment, printing and magnetic recording, in the order, on the inserted recording paper 100 and discharges the recording paper 100 after completion thereof.

In the standby status before inserting a recording paper 100, the pressure-application roller 310 and the transport roller 324 are in stoppage. In the standby status, the cam-link mechanism of this embodiment is in the first status. Namely, the alignment plate 360 is ascended to a position obstructing the transport path of recording paper 100, the clamper 32 is retracted above where not to obstruct the clamper 32 from moving, and the movable paper guide 851 closes the scanning path of magnetic head 410. Meanwhile, because the pushup member 351 is positioned in an upper position, the pressure-application roller 310 is weak in urge force.

Here, explanation is made on the drive control to a stepping motor 811 at initialization (original position setting) on the first cam 390 structuring a driven member.

During initialization, the stepping motor 811 is rotated until the cam follower pin 398, structuring the driven member similarly, hits against the stroke end 393 serving as a original position setting member shown in FIG. 15, thereby rotating the first cam 390 until the stepping motor 811 goes into stepping-out. This can positively align the end of the cam groove 392 with the cam follower pin 398.

First, explained is the load variation on the recording apparatus 10 of this embodiment.

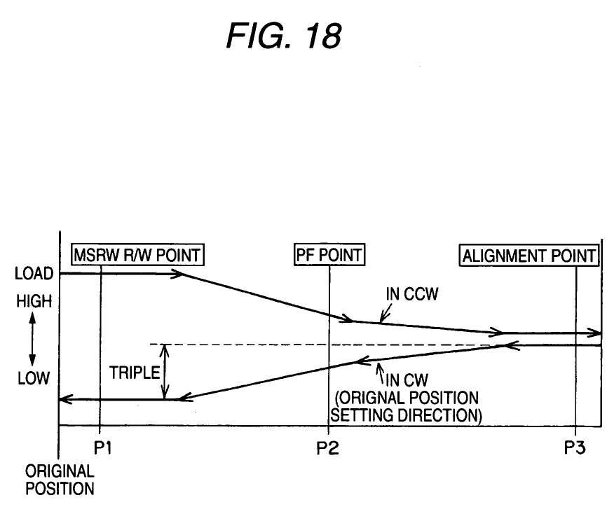

FIG. 18 is a figure explaining the load variation.

In the case when the first cam 390 is rotated forwardly (shown at CCW in FIG. 18), load is the highest at position P1, a read/write position (shown as MSRW R/W position, in the figure) of the magnetic data reader/writer 40. Load is next highest at position P2, a transport position (shown as PE position, in the figure) of recording paper. Load is the lowest at position P3, an alignment position.

Conversely, in the case when the first cam 390 is rotated reversely (shown at CW in FIG. 18), i.e. in a direction to set the original position, load is the lowest at position P1, a read/write position in the magnetic data reader/writer 40 (shown MSRW R/W position in the figure) (because the load of the compression coiled spring 836 acts toward the auxiliary). Load is next lowest at position P2, a position (shown as PF position, in the figure) transporting the recording paper (because the load of the spring urging the not-shown pressurizing roller 310 acts toward the auxiliary). Load is the greatest at position P3, an alignment position (because of no load acting toward the auxiliary).

For this reason, in this embodiment, torque, etc. of stepping motor 813 is selected to enable positive operation even in the region higher in load. Accordingly, in the case of performing an initialization, it can be considered to make a driving on a great torque in a region around the original position where load is low. Even when the cam follower pin 398, in a great torque state, hits against the stroke end 393 serving as an original position setting member, the first cam 390 is roughly fed (first mode) for driving in a crude way followed by an operation of fine feeding (second mode) in order to reduce the effect of bounce.

In this case, when performing a rough-feed operation by the first mode, consideration is given to a bounce due to reaching the original position. In order to suppress the bounce amount to a minimum, there is a need to carry out a slow-up control and slow-down control during driving of the first cam 390 (each waveform constituting the first mode may be hereinafter referred to first drive pattern) Furthermore, there is a need to structurally reduce the region of constant-speed operation in order not to synchronize the stepping motor 813 in the reverse rotational direction during bounce. Therefore, the rough-feed operation is periodically implemented.

Similarly, when making a fine-feed operation by the second mode, consideration is given to a bounce due to reaching the original position. There is a need to structurally reduce the region of constant-speed operation in order not to place the stepping motor 813 in synchronism in the reverse rotational direction during bounce (each waveform constituting the second mode may be hereinafter referred to second drive pattern). Therefore, the fine-feed operation is periodically implemented.

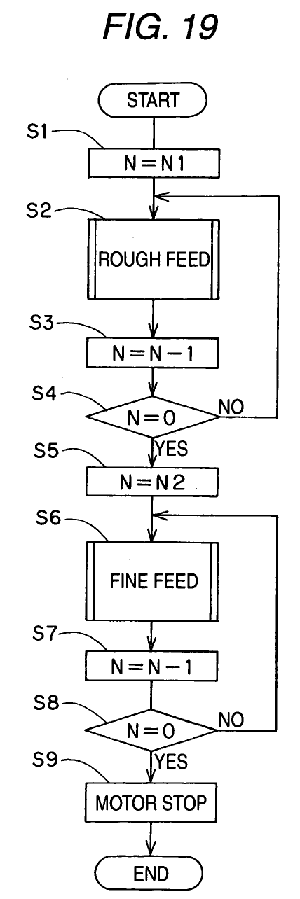

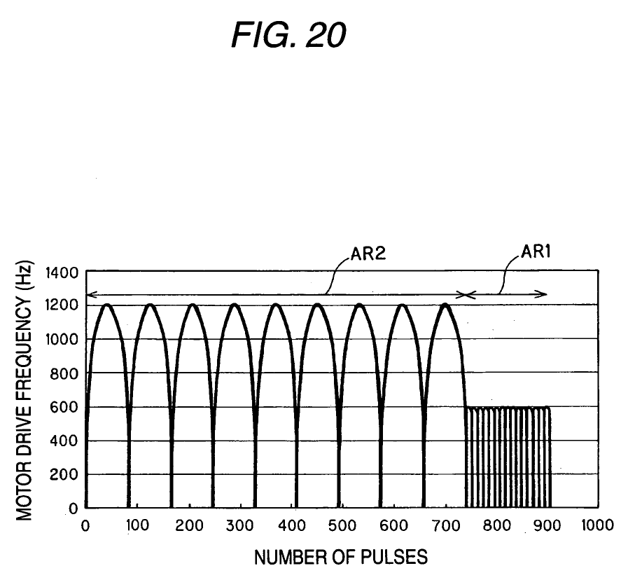

FIG. 19 is a flowchart of a process at an initialization in the embodiment. FIG. 20 is an explanatory view of a motor-drive waveform in the embodiment, based on the flowchart of FIG. 19.

First, the control section, not shown, of the recording apparatus 10 provides the value of process counter N as an initial value N1 for rough-feed operation (step S1). In the case of FIG. 20, N1=9 is given. The initial value N1 is to define the number of times of rough-feed operations to perform. This defines the number of times of repetitions of a drive operation increasing to a predetermined drive frequency (1200 Hz, in FIG. 20) while making a slow-up control and a stop operation for stop while making a slow-down control from a predetermined drive frequency (first drive pattern), in a region AR2 in FIG. 20, i.e. in a region considered not reached a region where the cam follower pin 398 is presumed to be in a position close to the original position (stroke end 393).

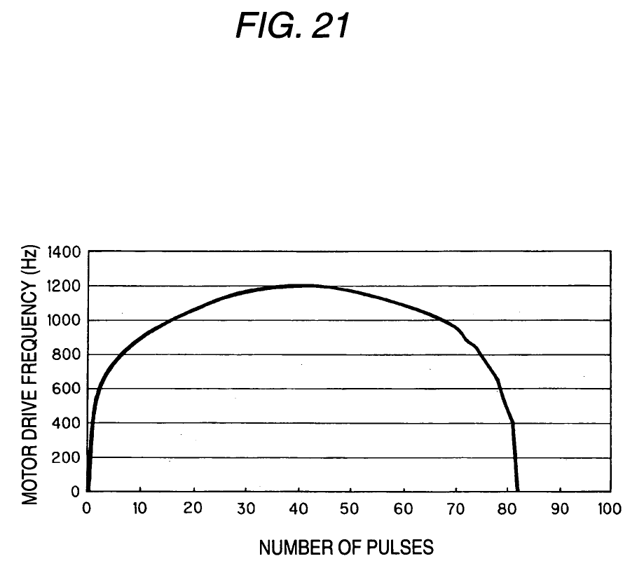

Then, the control section causes the stepping motor 813 to make a rough-feed operation, through a motor driver circuit, not shown (step S2). Specifically, as shown in magnified waveform diagram of FIG. 21, in the duration before the drive pulse generated becomes a predetermined number of pulses (81 pulses in the embodiment), drive operation is performed to raise the motor drive frequency from 0 Hz to 1200 Hz while making a slow-up control, and stop operation is performed to reduce the motor drive frequency down to 0 Hz while making a slow-down control from the motor drive frequency of 1200 Hz.

Subsequently, the control section subtracts 1 from the value of process counter N, providing it as a value of new process counter N (step S3).

Furthermore, the control section decides whether or not the value of process counter N is 0, and decides whether or not rough-feed operation by the first mode has been repeated the number of times designated to the initial value N (step S4).

When, in the step S4 decision, the value of process counter N is not yet 0 and hence rough-feed operation has not been repeated the number of times designated to the initial value N (step S4, No), the process is again moved to step S2, to perform the similar operation from then on.

When, in the step S4 decision, the value of process counter N is 0 and hence rough-feed operation has been repeated the number of times designated to the initial value N1 (step S4, Yes), the control section sets the value of process counter N to the initial value N2 for fine-feed operation by the second mode (step S5). In the case of FIG. 20, N2=15 is given. The initial value N2 is to define the number of times of fine-feed operations by the second mode to perform. In the case reaching the region AR1 in FIG. 20, that is, in an end side region of the returning step where it is presumed that the cam follower pin 398 is in a position close to the original position (stroke end 393), slow-up control is not made but the stepping motor 813 is simply driven to a predetermined drive frequency (600 Hz, in FIG. 20), to repeat the drive operation for driving for a duration before the generated drive pulses of the second drive pattern becomes a predetermined number of pulses (10 pulses in the embodiment) and the stop operation for stop by rendering drive frequency=0 from a predetermined drive frequency. The total number of pulses of the second mode, that is, the summation of pulses of the each second drive pattern is set larger than the first drive pattern applied immediately before the second mode in order to positively set the driven member to the original position even in case the driven member is driven in a reverse direction on the last first drive pattern of the first mode, that is, the first drive pattern applied immediately before the second mode.

In the above structure, specifically, driving is on 81 pulses on each of the first drive pattern×9 times=729 pulses in rough-feed operation by the first mode while driving is on 10 pulses on each of the second drive pattern×15 times=150 pulses in fine-feed operation by the second mode, thus making a driving on 879 pulses in total. This example is on the case of the maximum number of drive pulses of 814 required from the original position up to the maximum drive position, wherein it is possible to obtain the similar effect to the embodiment provided that setting is made such that the total number of pulses of the number of drive pulses in rough-feed operation and the number of drive pulses in fine-feed operation is greater than the maximum number of drive pulses. Incidentally, the ratio of the number of drive pulses in rough-feed operation and the number of drive pulses in fine-feed operation can be suitably changed.

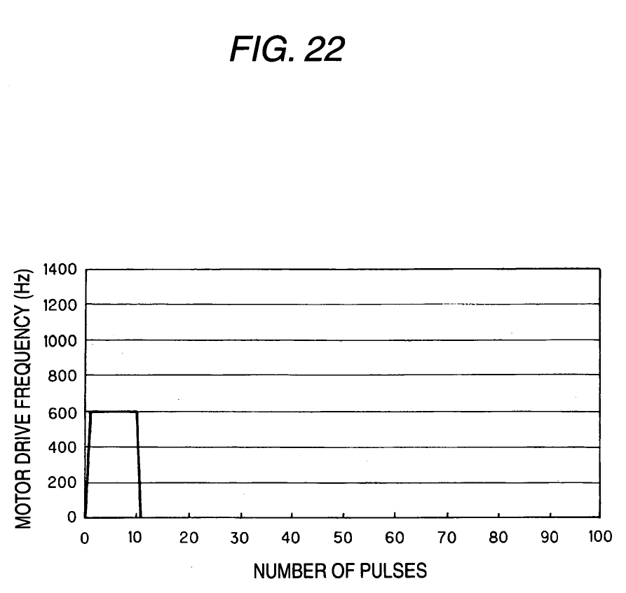

Then, the control section causes the stepping motor 813 to perform a fine-feed operation, through the not-shown motor driver circuit (step S6). Specifically, as shown in the magnified waveform diagram in FIG. 22, in the beginning of a period before the generated drive pulses becomes 10 pulses in number, the motor drive frequency is raised up to 600 Hz thus performing a drive operation. When the generated drive pulses becomes 10 pulses in number, stop operation is made to reduce the motor drive frequency at once from 600 Hz down to 0 Hz to stop.

Subsequently, the control section subtracts 1 from the value of process counter N, to render it as a value of new process counter N (step S7).

Furthermore, the control section decides whether or not the value of process counter N is 0, and decides whether or not fine-feed operation has been repeated the number of times designated to the initial value N2 (step S8).

When, in the step S8 decision, the value of process counter N is not yet 0 and hence fine-feed operation has not been repeated the number of times designated to the initial value N2 (step S8, No), the process is again moved to step S6, to perform the similar operation from then on.

When, in the step S8 decision, the value of process counter N is 0 and hence fine-feed operation has been repeated the number of times designated to the initial value N2 (step S8, Yes), it is presumed that the cam follower pin 398 is already abutted against the stroke end 393 thus being in the original position. Hence, the stepping motor 813 is stopped from driving thus ending the process (step S9).

In this manner, this embodiment does not require a detector for setting a position of the first cam 390, making it easy to reduce the cost and size of the recording apparatus 10. Even when using a stepping motor having a great drive torque, the cam follower pin 398 can be moved to the original position, whereby the adverse effect of a bounce of the cam follower pin 398 when it hits against the stroke end 393 is prevented. Thus, initialization can be positively performed.

When a recording paper 100 is inserted in the standby status after completing the initialization, the pressure-application roller 310 and transport roller 324 rotates, to transport the recording paper 100 while clamping it at a weak urge force. After the recording paper 100 at its tip abuts against the alignment plate 360, the pressure-application roller 310 and transport roller 324 are rotated further, thereby aligning the recording paper 100.

After the recording paper 100 is aligned, the first cam rotates forward nearly a half turn, thereby changing the cam-link mechanism from the first status into a second status. Namely, the pushup member 351 descends. This increases the urge force of the pressure-application roller 310, to clamp the recording paper 100 at a strong force by the pressure-application roller 310 and transport roller 324. Furthermore, associatively with descend of the pushup member 351, the alignment plate 360 also descends and retracts from the transport path of recording paper 100. At this time, because the first cam follower 817 is not changed in position from the first status, the clamper 32 and movable paper guide 851 are in the same state as the first status. In this state, by forward rotation of the pressure-application roller 310 and transport roller 324, the recording paper 100 is transported to a recording position. When recoding is over, the pressure-application roller 310 and transport roller 324 rotate reversely to thereby transport the recording paper 100 to a magnetic read/write position.

When the recording paper 100 is transported to the magnetic read/write position, the first cam 390 further rotates forward a half turn. Due to this, the cam-link mechanism changes from the second status into a third status. Namely, the clamper 32 descends down to a position for urging the recording paper 100 onto the magnetic head 410 while the movable paper guide 851 retracts down out of the transport path of recording paper 100 thereby releasing the scan path for the magnetic head 410. At this time, because the pushup member 351 is not changed from the second status, there is similarly no change in the alignment plate 360 position and pressurizing roller 310 urge force from that of the second status. In this state, the magnetic head 410 scans the magnetic stripe 110 and makes a reading/writing of magnetic data.

When the scanning over the magnetic stripe 110 by the magnetic head 410 is over, the first cam 390 rotates reversely a half turn. This changes the cam-link mechanism from the third status into a second status. Namely, the clamper 32 releases the hold of the recording paper 100 and retracts to the above. Simultaneously, the movable paper guide 851 rotates up and advances in the transport path of recording paper 100 thereby closing the scanning path for the magnetic head 410. At this time, because the pushup member 351 does not change in position from the third status, there is similarly no change in the alignment plate 360 position and pressurizing roller 310 urge force from that of the third status. In this state, the pressure-application roller 310 and transport roller 324 rotate reverse to discharge the recording paper 100 out of the recording apparatus 10. By the above, completed is the operation in series based on the present timing chart.

As described above, by a rotation in the same direction, the first cam 390 begins to drive the alignment plate 360, the clamper 32 and the movable paper guide 851 in different timing. Accordingly, the load onto the motor 811 as a power source can be decentralized. This makes it possible to construct the stepping motor 811 of a minimal size. Meanwhile, by changing over between the three pattern of transport status in combination of the alignment plate 360, the clamper 32 and the movable paper guide 851 (the first, second and third statuses) due to simple operation of the same first cam 390, the cam-link mechanism can be reduced in size. Accordingly, a small, low-cost recording apparatus 10 can be provided for accurately reading/writing a magnetic stripe 110.

In the above explanation, when performing a rough-feed operation during the initialization operation, drive operation is performed to raise the motor drive frequency from 0 Hz to 1200 Hz while making a slow-up control in a duration before generated drive pulses becomes 81 pulses in number, as shown in the magnified waveform diagram of FIG. 21, wherein a stop operation is made by reducing the motor drive frequency to 0 Hz while making a slow-down control from the motor drive frequency of 1200 Hz. However, the motor drive frequency cannot be 0 Hz in order to improve throughput.

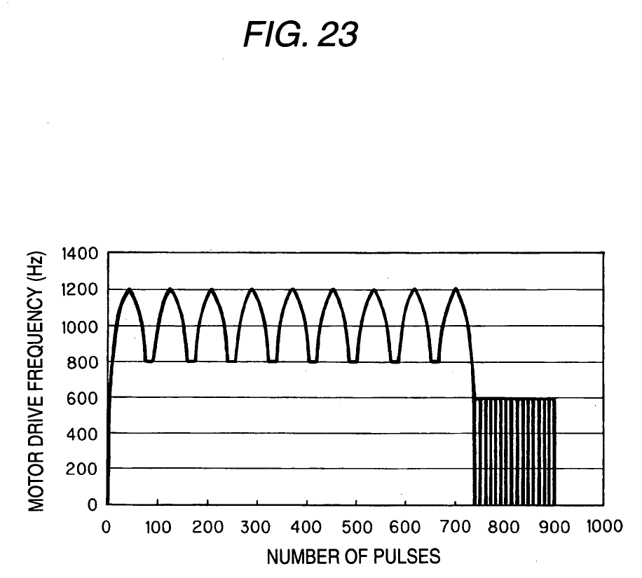

Specifically, as shown in FIG. 23, drive operation is performed to raise the motor drive frequency from 0 Hz to 1200 Hz while making a slow-up control, and reduce the motor drive frequency from 1200 Hz to 800 Hz while making a slow-down control, which operation by the first drive pattern is carried out (N1−1) times. In the N1-th round of the first drive pattern, stop operation is made to reduce the motor drive frequency to 0 Hz for stop (first mode). Here, when it reverts to 800 Hz, in view of throughput and prevention of reverse rotation due to impact, it is preferable to set the value from 70 to 50% of the first upper-limit frequency so that impact thereon falls within 50 to 25% compared with the impact on the first upper-limit frequency 1200 Hz. In the above explanation, when performing a rough-feed operation during the initialization operation, slow-up control and slow-down control were performed in the duration before the generated drive pulses became a constant number of pulses as shown in the magnified waveform diagram in FIG. 21. However, this duration can be provided variable.

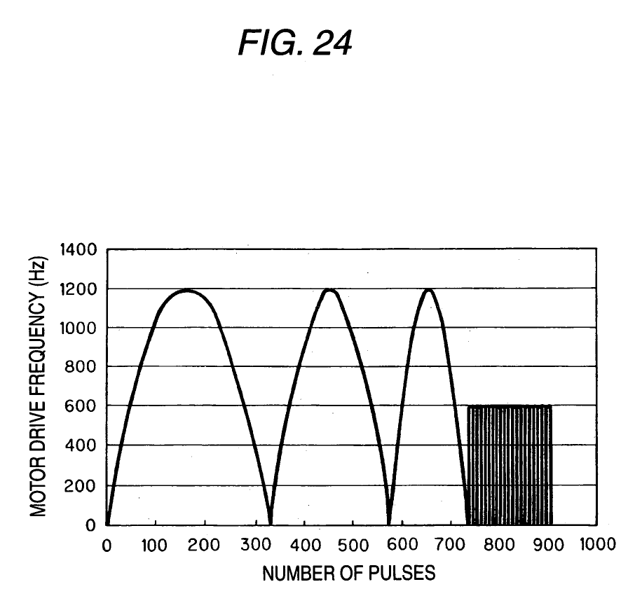

Specifically, as shown in FIG. 24, the motor drive operation, in the first round of slow-up control and slow-down control, is performed in a period before the generated drive pulses become 324 (=81×4) in number. The motor drive operation, in the second round of slow-up control and slow-down control, is performed in a period before the generated drive pulses become 243 (=81×3) in number. The motor drive operation, in the third round of slow-up control and slow-down control, is performed in a period before the generated drive pulses become 162 (=81×2) in number.

Although the above explanation was made with reference to the example of the cam-link mechanism including the first cam 390 and cam follower pin 398 as a driven member, the present invention is not so limited. The present invention is applicable to the case where, in an apparatus high in load variation, the driven member is driven by a stepping motor, to set the original position in a high torque state.

In the above explanation, the first cam 390 and the cam follower pin 398 comprised a cam-link mechanism for changing over the positions of all the alignment plate 360 for recording paper alignment, the movable paper guide 851 for recording paper guidance or clamper 32 for recording paper holding down. However, it may comprise a cam-link mechanism for changing over the positions of at least any of the alignment plate 360, the movable paper guide 851 and clamper 32.

What is claimed is:

1. An original position setting apparatus for driving a driven member by a stepping motor and abutting the driven member against an original position setting member to set an original position of the driven member,
wherein the original position apparatus comprises
a drive control section that periodically drives the stepping motor until the driven member abuts the original setting member, when the driven member is returned to the original position.

2. The original position setting apparatus according to claim 1, wherein the drive control section repeats a drive-stop operation of performing a drive operation for raising to a predetermined drive frequency while making a slow-up control and a stop operation for stop while making a slow-down control from the predetermined drive frequency.

3. The original position setting apparatus according to claim 2, wherein the drive control section repeats a drive-stop operation having a period of a predetermined number of pulses, while gradually decreasing the predetermined number of pulses.

4. The original position setting apparatus according to claim 1,
wherein the drive control section repeats a drive-stop operation comprising at least a first mode and a second mode which is implemented after the first mode.

5. The original position setting apparatus according to claim 4, wherein the first mode has a first drive frequency higher than that of the second mode and the first mode has the total number of pulses greater than that of the second mode.

6. The original position setting apparatus according to claim 5, wherein in the first mode, the drive control section repeats a drive operation for raising to a predetermined drive frequency while making a slow-up control and a stop operation for stop while making a slow-down control from the predetermined drive frequency.

7. The original position setting apparatus according to claim 6, wherein in the second mode, the drive control section repeats a drive operation and stop operation of the stepping motor in order to repeat a fine feed of the driven member.

8. The original position setting apparatus according to claim 7, wherein in the first mode, the drive control section performs a drive operation repeating a first drive operation for raising to a first drive frequency while making a slow-up control and a second drive operation for driving by reducing down to a second drive frequency lower than the first drive frequency while making a slow-down control from the first drive frequency, and then performs a stop operation.

9. The original position setting apparatus according to claim 7, wherein in the first mode, the drive control section repeats a drive-stop operation, having a period of a predetermined number of pulses, of performing a drive operation for raising to a predetermined drive frequency while making a slow-up control and a stop operation while making a slow-down control from the predetermined drive frequency, while gradually decreasing the predetermined number of pulses.

10. A recording apparatus comprising:
a recording head;
a stepping motor;
a driven member that is driven by the stepping motor; and
an original position setting apparatus for setting an original position of the driven member by abutting the driven member against an original position setting member, wherein the original position setting apparatus comprises a drive control section, and wherein the drive control section repeats a drive-stop operation comprising at least a first mode and a second mode which is implemented after the first mode.

11. The recording apparatus according to claim 10, wherein the first mode has a first drive frequency higher than that of the second mode and the first mode has a total number of pulses greater than that of the second mode, wherein in the first mode, the drive control section repeats a drive operation for raising to a predetermined drive frequency while making a slow-up control and a stop operation while making a slow-down control from the predetermined drive frequency, and
wherein in the second mode, the drive control section repeats a drive operation and stop operation of the stepping motor in order to repeat a fine feed of the driven member.

12. The recording apparatus according to claim 11, wherein in the first mode, the drive control section performs a drive operation repeating a first drive operation for raising to a first drive frequency while making a slow-up control and a second drive operation for driving by reducing down to a second drive frequency lower than the first drive frequency while making a slow-down control from the first drive frequency, and then performs a stop operation.

13. The recording apparatus according to claim 11, wherein in the first mode, the drive control section repeats a drive-stop operation, having a period of a predetermined number of pulses, of performing a drive operation for raising to a predetermined drive frequency while making a slow-up control and a stop operation while making a slow-down control from the predetermined drive frequency, while gradually decreasing the predetermined number of pulses.

14. A method of controlling an original position setting apparatus for driving a driven member by a stepping motor and abutting the driven member against an original position setting member to set an original position of the driven member, the method comprising a returning step for returning the driven member to the original position,
wherein in the returning step, a drive mode of the stepping motor comprises at least two drive pattern having slow-up and slow-down.

15. The method according to claim 14, wherein the drive mode comprises:
a first mode in which a plurality of first drive patterns having a first upper-limit frequency is applied; and
a second mode in which a plurality of second drive patterns having a second upper-limit frequency is applied after the first mode, the second upper-limit frequency being lower than the first upper-limit frequency.

16. The method according to claim 15,
wherein the total number of pulses applied in the second mode is larger than the number of pulses of one first drive pattern applied immediately before the second mode.

17. The method according to claim 14, wherein in the drive mode, a predetermined frequency is applied after the slow-down of previous first drive pattern and then the slow-up of next first drive pattern is applied.

18. The method according to claim 17, wherein the predetermined frequency is from 70% to 50% of the first upper-limit frequency.
